(19) United States
(12) Patent Application Publication
(10) Pub. No.: US 2009/0183419 A1
(43) Pub. Date: Jul. 23, 2009

(54) Insect trap

(76) Inventor: Scott K. Harris, Portland, OR (US)

Correspondence Address: Jerome E Sacks;Patent Agent, PO Box 601, Lexington, MA, 02420, US

(21) Appl. No.: 12/321,515

(22) Filed: Jan. 22, 2009

Related U.S. Application Data
(60) Provisional application No. 61/022,951, filed on Jan. 23, 2008.

(51) Int. Cl. A01M 1/14

(52) U.S. Cl. 43/114; 43/132.1

(57) ABSTRACT

The invention is a insect trapping device comprising a truncated, tapered hollow body such as a truncated cone or pyramid having a nondrying glue substantially covering its interior surface. The glue has a removable covering that protects it when it is in its package or ready to deploy configuration. It may be placed on a horizontal surface with the large opening facing down or hung in an overhead position with the large opening facing up. The device may be sized for different applications: a large version placed over dung in a field will capture house flies, while a smaller version put on a countertop using overripe fruit as an attractant will capture fruit flies. Various embodiments are presented that allow the embodiment to be folded, stacked, or flattened for storage. The invention traps members of the insecta class (e.g. flies), members of the arachnid class (e.g. spiders) and other arthropods.

### CROSS-REFERENCE TO RELATED APPLICATIONS

This application claims the benefit of the U.S. Provisional Patent Application No 61/022,951 filed Jan. 23, 2008 by the present inventor. This provisional patent application is incorporated herein by reference.

### FIELD OF THE INVENTION

This invention relates to devices that trap insects; more specifically to devices that trap insects using a nondrying glue such as found on flypaper and glue boards.

### BACKGROUND OF THE INVENTION

There are many types of insect traps designed to capture and kill insects, both flying and crawling. A very common type uses a nondrying glue that the insect sticks to upon contact. Traps using nondrying glues are a mature product area. Coiled flypaper ribbons, flypaper boards and sheets using nondrying glue are currently widely available. There are also numerous patents addressing more elaborate products using nondrying glue; they often incorporate additional features such as lights to attract the insects, containers to catch insect corpses, and capabilities to fold the invention to facilitate shipping and storing.

However all these products have one or more limitations, and their commercial success is extremely limited. They may be messy to deploy, unpleasant to look at, expensive to build, and have limited marketability because of their restricted use. Therefore, there is a need for a simple device that is inexpensive to manufacture, may be displayed nicely in its packaged configuration on a merchant's shelf, does not have an unpleasant appearance when in use, is easy to deploy and dispose of, and can be designed for a wide range of price points. The invention presented herein achieves all of these objectives.

### SUMMARY OF THE INVENTION

The inventive solution presented here is a insect trapping device comprising a truncated, tapered, hollow body such as a truncated cone or pyramid. It incorporates a nondrying glue such as that used in flypaper that substantially covers its interior surface. It optionally accommodates user-supplied attractants, such as dung for houseflies or overripe fruit for fruit flies. It may be packaged by folding, stacking, or lying flat, depending upon the design details. The invention therefore overcomes the limitations of the prior art as it is easy to package, deploy and dispose of, may be manufactured cheaply, accommodates the insect's user-supplied natural attractants, hides the captured insects from public view when in use, and may be applied in a variety of different applications—from use in an open field or inside a barn to sitting on a kitchen countertop.

The inventive solution has many features that add to its usefulness. It is manufactured from materials based upon cost/benefit considerations chosen to meet both desired price points and its effectiveness for its intended use. It can be manufactured using stiff cardboard, plastic or other materials, and may be waterproofed or not. The color and indicia on the exterior may be selected for aesthetic considerations, as when it is used on a kitchen counter, or may be used to attract insects as when used in a field. The nondrying glue can be selected to meet its intended applications. It may contain attractants such as pheromones and/or poisons such as insecticides. Glues intended to capture fruit flies will have a different viscosity and other properties than glues that capture houseflies.

### BRIEF DESCRIPTION OF THE DRAWINGS

FIGS. 1A and 1B illustrate the terms annulus and annulus segment.

FIG. 1C illustrates a truncated cone constructed from an annulus segment.

FIGS. 2A, 2B and 2C illustrate the concept of a truncated, tapered hollow body.

FIG. 3 illustrates a first embodiment in its deployed configuration.

FIGS. 4A and 4B illustrate the first embodiment in its packaged and ready to deploy configuration.

FIGS. 5A and 5B illustrate a second embodiment in its packaged and ready to deploy configuration.

FIG. 5C illustrates a third embodiment in its ready to deploy configuration.

FIGS. 6A through 6D illustrate three different deployment scenarios of the first embodiment.

FIGS. 7A and 7B illustrate designs for a four-sided truncated pyramid in its deployed and packaged configuration.

FIGS. 8A through 8C illustrate designs for a six-sided truncated pyramid in their deployed and packaged configurations.

### DETAILED DESCRIPTION OF THE INVENTION

Definitions

The terms sticky, annulus and annulus segment, insect, truncated, tapered hollow body, and embodiment configurations are defined here.

Sticky is used in this specification as a noun to specify a nondrying glue that is used to trap insects as commonly used in flypaper and fly boards. The actual composition of the sticky depends on the intended application. Sticky may contain an attractant that will lure the insects, and contain insecticides that will kill the insect once it is trapped.

The term annulus refers to a sheet that has the shape of the area between two concentric circles. Referring to FIG. 1A, the annulus 102 is the shaded portion between the concentric circles 104 and 106. Referring now to FIGS. 1A and 1B, the term annulus segment 110 refers to an annulus that has a segment removed where the segment is the smaller area between two radial lines 108a and 108b emanating from the center of the annulus. The annulus segment in FIG. 1B is the shaded area.

The term insect is defined in this specification to be interpreted generally as used in ordinary conversation. It includes members of the insecta class (e.g. flies), members of the arachnid class (e.g. spiders) as well as other arthropods (excluding crustaceans).

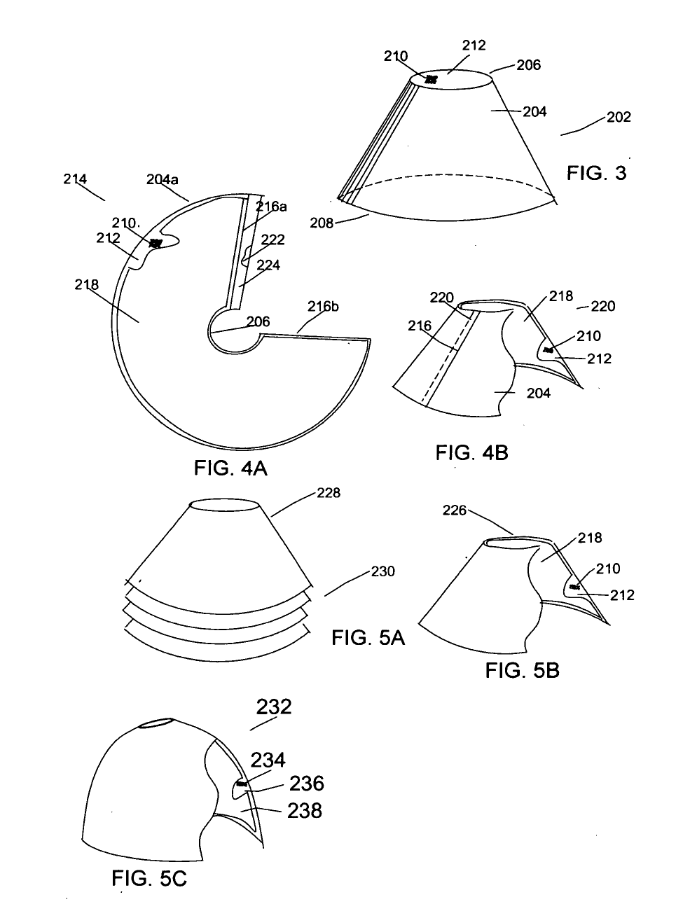

An embodiment of the invention has three configurations; the packaged configuration, the ready to deploy configuration and the deployed configuration. The packaged configuration is the configuration when is in on a merchant's shelf. The ready to deploy configuration is the configuration where is has its final form ready to be put into use, but the nondrying glue covering is in place. The deployed configuration is when it is put in use and able to catch insects. FIGS. 4A, 4B and 3 respectively show these three configurations for the truncated cone of the first embodiment.

The term truncated, tapered hollow body refers to a hollow body that has two open ends, a larger open end and a smaller open end, and is tapered from the larger open end to the smaller open end such that several of these bodies of the same dimension are stackable. Examples of truncated, tapered hollow bodies are the truncated cone 228, the truncated four-sided 402 and six-sided pyramids 406, the beehive tapered cone 232 and the curved tapered cone 234.

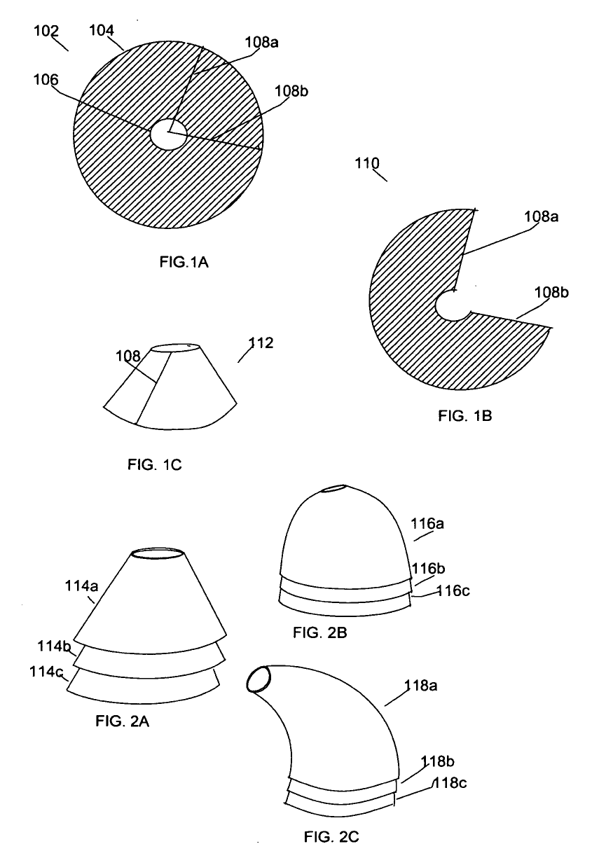

Referring now to FIG. 2A, the conical truncated tapered hollow body 114a is shown. It is stacked on two other conical truncated tapered hollow bodies 116b and 116c of the same dimensions. FIGS. 2B and 2C respectively show two other examples of truncated, tapered hollow bodies, the beehive truncated, tapered hollow body 116a and the curved truncated, tapered hollow body 118a. As shown in the figures, the beehive hollow bodies 116a, 116b and 116c are stacked. Similarly, the curved hollow bodies 118a, 118b and 118c are stacked.

### Embodiment One

FIG. 3 displays the first embodiment in its deployed configuration 202. It consists of a hollow, substantially rigid, truncated cone 204 with a small opening 206 at the narrow end of the tapered cone and a second larger opening 208 at the wider end of the cone. Its interior surface 212 is substantially coated with sticky.

FIG. 4A illustrates the first embodiment in a packaged configuration as it would be stored or displayed in a merchant's store. FIG. 4B shows the ready to deploy configuration of the first embodiment constructed by reconfiguring the packaged configuration into a conical shape.

Referring now to FIGS. 4A and 4B, the ready to deploy configuration 220 of the first embodiment, constructed from the packaged configuration 214, consists of the truncated cone 204, with sticky 210 substantially covering the interior surface 212 of the truncated cone 204. The sticky is covered by a removable covering 218. The truncated cone 204 is constructed from a flat material, such as heavy cardboard, in the shape of an annulus segment 204a. The annulus segment 204a is joined 216 at the radial edges 216a and 216b of the annulus segment 204a using an adhesive strip 222 after removing the adhesive strip covering 224.

### Embodiment Two

FIGS. 5A and 5B illustrate the construction of a second embodiment in its packaged configuration and its ready to deploy configuration. Referring to FIG. 5B, the ready to deploy 226 configuration of the second embodiment has the same structure of the ready to deploy configuration of FIG. 4B, but with one difference. Instead of constructing the truncated cone 204 from an annulus segment 204a, the truncated cone 228 is already manufactured as a hollow body. The truncated cone 226 has sticky 210 applied to its interior 212. The covering 218 is made from an annulus segment 218 as in FIG. 4A. FIG. 5A shows how this embodiment is packaged. Referring to FIG. 5A, several or many units of the second embodiment 228 are stacked one on top of the other 230. This will display nicely on a merchants shelf and will pack nicely for shipping. FIG. 5B show a ready to deploy unit. It is essentially the same as shown in FIG. 4B.

### Embodiment Three

FIG. 5C illustrates a design for a third embodiment, the beehive design, that is in its ready to deploy configuration. The single beehive 232 has sticky 234 substantially covering its interior 236 (not shown in the figure). It also has a removable covering cover for the sticky 238. As in the second embodiment, the third embodiment is stackable as shown in FIG. 2B.

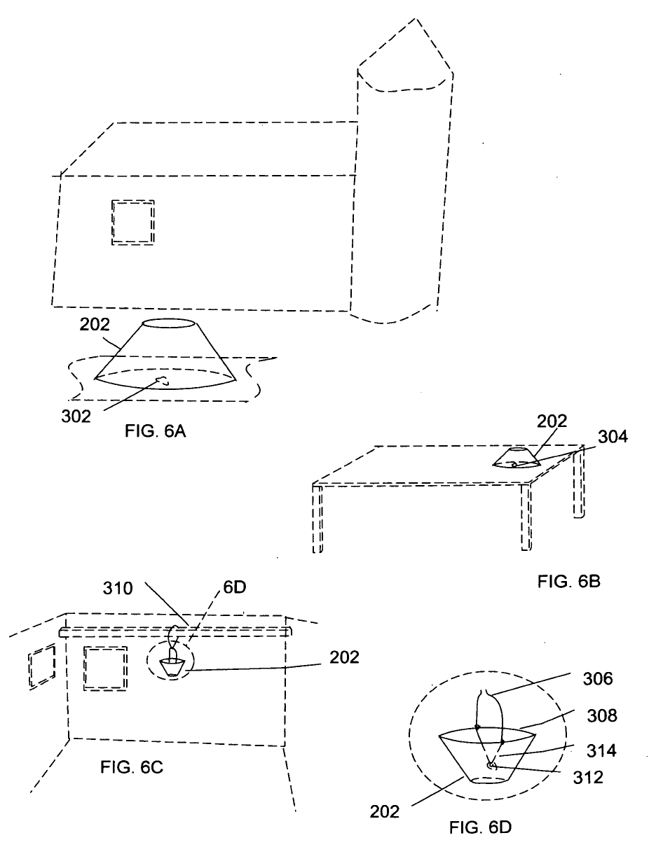

The size of the various embodiments may vary widely depending on their intended use. FIG. 6A shows the first embodiment of the insect trap used in a field where large animals, such as cows or horses, graze. A pile of animal dung 302 lies on the ground and attracts flies. The insect trap is placed over the dung, and will trap the flies as they are attracted to the dung. In this application the cone is relatively large, the height typically about 40.5 cm (16 in). A “muck bucket” filled with manure or other substances that attracts flies found in a field may also be used.

FIG. 6B shows a much smaller version of the first embodiment of the insect trap 202 that is used indoors on a flat surface, such as a counter or table. In this case the insect trap lies on a flat level surface. As show in the figure the insect trap has attractants 304 resting on the surface that will attract the insect. If fruit flies are the insect to be caught, the attractants may be a slice of overripe fruit. Alternately, the trap may not have an attractant; the sticky may incorporate an attractant that will lure the insects. As compared to FIG. 6A, this version typically may be approximately 25 cm (10 in) or smaller in height.

FIGS. 6C and 6D show a third application. Here the insect trap is used indoors, such as in a barn. It is hung with the truncated cone 202 inverted with the wide end 308 facing the ceiling. String 306 is attached to the insect trap and to a rafter 310 in the barn. FIG. 6D illustrates this embodiment. The size of this embodiment may be similar to that of FIG. 6A and may contain a similar attractant. Also shown in FIG. 6D is a user supplied attractant 312 attached by a mechanism such as a hook and a string 314.

### Embodiment Four

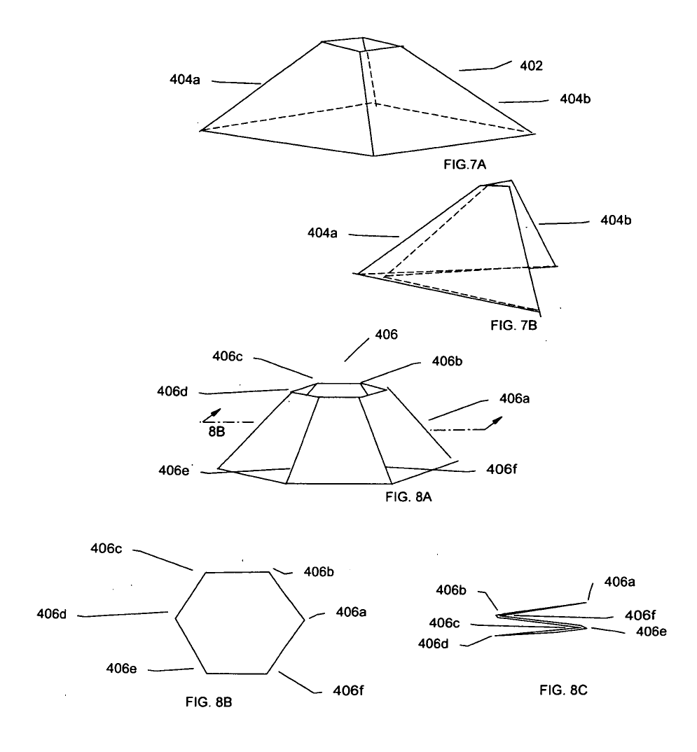

FIGS. 7A and 7B illustrate a fourth embodiment. Referring now to FIG. 7A, a truncated, tapered hollow body in the shape of a four-sided pyramid 402 replaces the tapered truncated hollow cone of the first embodiment. Although not shown in the figure, it has sticky applied to its interior surface and has a removable covering to protect the sticky. In its packaged configuration, the fifth embodiment may be folded nicely for packaging. Referring to FIGS. 7A and 7B, to fold the fifth embodiment for packaging, edge 404b is moved towards edge 404a and the unit is folded as shown in FIG. 7B. For this embodiment the material that is used to make the pyramid must have sufficient flexibility and the dimension of each side must depart slightly from the sides of a regular pyramid in a manner such that the folds may be made and the folded embodiment lies flat.

### Embodiment Five

In a fifth embodiment, shown in FIG. 8A, a tapered truncated hollow hexagonal pyramid replaces the truncated, tapered hollow cone of the first embodiment. This also folds nicely as the cross segment shown in FIG. 8B has its edges labeled to describe the folding technique. First edge 206a is folded inward so edge 406f is moved towards edge 206b. Then edge 206e is folded inward so its edge 206c moves towards it. The whole unit is then flattened for packaging. As in the fourth embodiment, the dimension of each side of the truncated hexagonal pyramid will depart slightly from the sides of a regular pyramid so the inside folds may be made and the folded embodiment will lie flat.

The disclosure presented herein gives five embodiments of the invention. These embodiments are to be considered as only illustrative of the invention and not a limitation of the scope of the invention. Various permutations, combinations, variations and extensions of these embodiments are considered to fall within the scope of this invention. Therefore the scope of this invention should be determined with reference to the claims and not just by the embodiments presented herein.

What is claimed is:

1. A insect catching device comprising a tapered, truncated, hollow body having a nondrying glue substantially covering an interior surface of the body.

2. The device of claim 1 further comprising a removable covering for said nondrying glue.

3. The device of claim 1 wherein the body of the device may be folded for packaging.

4. The device of claim 1 wherein the body of the device is shaped to stack a plurality of devices one on top of the other.

5. The device of claim 1 further comprising an insect attractant disposed within the nondrying glue.

6. The device of claim 1 further comprising an insecticide disposed within the nondrying glue.

7. A insect catching device comprising a truncated, hollow cone having a nondrying glue substantially covering an interior surface of said cone.

8. The device of claim 7 further comprising a removable covering for said nondrying glue.

9. The device of claim 7 further comprising an insect attractant disposed within said nondrying glue.

10. The device of claim 7 further comprising an insecticide disposed within said nondrying glue.

11. The device of claim 7 further comprising a holder for a user-provided insect attractant.

12. A method for constructing an insect catching device in a packaging configuration comprising the steps of
a. providing a first annulus segment with a first side, a second side, a first radial edge and a second radial edge,
b. substantially covering said second side of said first annulus segment with a nondrying glue,
c. removably attaching a second annulus segment comprising a removable covering of said second side of said first annulus segment,
d. providing an adhesive strip with a first side and a second side, said adhesive strip being attached to said first radial edge such that said first side of said adhesive strip is positioned on the same side as said second side of said annulus segment, said adhesive substantially covering said adhesive strip on said second side,
e. said first side of said adhesive strip being covered by a removable adhesive covering.

13. The method of claim 12 further comprising a ready to deploy configuration comprising the steps of
a. folding said insect catching device in said packaged configuration into a conical configuration by removing said removable adhesive covering of said adhesive strip, and
b. attaching said adhesive strip to said first annulus segment wherein said first radial edge and said second radial edge abut each other.

14. The method of claim 13 wherein said insect trapping device is deployed comprising the steps of
a. removing said covering of said first annulus segment,
b. placing said insect trapping device over a natural attractant.

15. The method of claim 14 wherein said insect trapping device is deployed comprising the steps of
a. removing said second annulus segment,
b. hanging said insect trapping device with a large open end facing up from a first hanging means,
c. adding an attractant to said insect trapping device by a second hanging means.
